(19) United States
(12) Patent Application Publication
(10) Pub. No.: US 2026/0276154 A1
(43) Pub. Date: Sep. 17, 2026

(54) Propane Manifold Assembly

(71) Applicant: Dean De Meio, Port Lavaca, TX (US)

(72) Inventor: Dean De Meio, Port Lavaca, TX (US)

(21) Appl. No.: 19/081,670

(22) Filed: Mar. 17, 2025

(51) Int. Cl. F17C 13/04

(52) U.S. Cl. CPC F17C 13/04; F17C 2205/0323; F17C 2205/0364; F17C 2205/037; F17C 2205/0388; F17C 2221/035

(57) ABSTRACT

A propane manifold assembly for quickly and easily attaching a plurality of appliances to a propane source includes a propane source storing a propane gas and a manifold with an inlet and a plurality outlets. A plurality of appliances are operationally coupled to the manifold. A plurality of manifold valves are coupled to the manifold wherein each manifold valve of the plurality of manifold valves is coupled to an associated manifold outlet of the plurality of manifold outlets. Each manifold valve of the plurality of manifold valves is actuatable to selectively inhibit transfer of the propane gas from the associated manifold outlet of the plurality of manifold outlets to an associated appliance of the plurality of appliances. A plurality of appliance connector fittings are couplable couples the plurality of manifold valves to the plurality of appliances. A hose fluidly couples the propane source to the inlet of the manifold.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to manifold assemblies and more particularly pertains to a new manifold assembly for quickly and easily attaching a plurality of appliances to a propane source.

### (2) Description of Related Art Including Information Disclosed Under 37 CFR 1.97 and 1.98

The prior art relates to manifold assemblies. Propane gas is a common power source for people who are camping or living a nomadic lifestyle because propane tanks are relatively easy to obtain and refill as needed. Propane gas is also a very stable fuel, posing very little risk of chemical decay, explosion, or other safety risks as long as the propane gas is stored correctly. People also prefer propane gas for situations such as travel because propane gas does not expire or loose its potency over time. However, most people utilize multiple types of appliances each day. However, typically, only a single appliance can be connected to a propane source at a time, meaning that users can only use a single appliance at a time. To use a different appliances, users need to disconnect the used appliance from the propane source before hooking up the new appliance for use. Thus, there is a need for a device that allows users to quickly and easily connect multiple appliances to a plurality of propane sources, allowing users to use multiple appliances simultaneously while also increasing the amount of time that users can run the appliances before running out of propane gas.

### (h) BRIEF SUMMARY OF THE INVENTION

An embodiment of the disclosure meets the needs presented above by generally comprising a propane source storing a propane gas. A manifold has a manifold inlet and a plurality of manifold outlets. The manifold inlet is in fluid communication with the propane source. A plurality of appliances are operationally coupled to the manifold wherein each appliance of the plurality of appliances is in fluid communication with a respective manifold outlet of the plurality of manifold outlets. The manifold transfers the propane gas from the propane source to each appliance of the plurality of appliances to power each appliance of the plurality of appliances. A plurality of manifold valves are coupled to the manifold wherein each manifold valve of the plurality of manifold valves is coupled to an associated manifold outlet of the plurality of manifold outlets. Each manifold valve of the plurality of manifold valves is actuatable to selectively inhibit transfer of the propane gas from the associated manifold outlet of the plurality of manifold outlets to an associated appliance of the plurality of appliances. A plurality of appliance connector fittings are couplable to the plurality of manifold valves wherein each appliance connector fitting of the plurality of appliance connector fittings couples an associated manifold valve of the plurality of manifold valves to the associated appliance of the plurality of appliances. A hose fluidly couples the propane source to the manifold inlet wherein the hose is designed to transfer the propane gas from the propane source to the manifold.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded view of a propane manifold assembly according to an embodiment of the disclosure.

FIG. 2 is a block diagram view of an embodiment of the disclosure.

### (j) DETAILED DESCRIPTION OF THE INVENTION

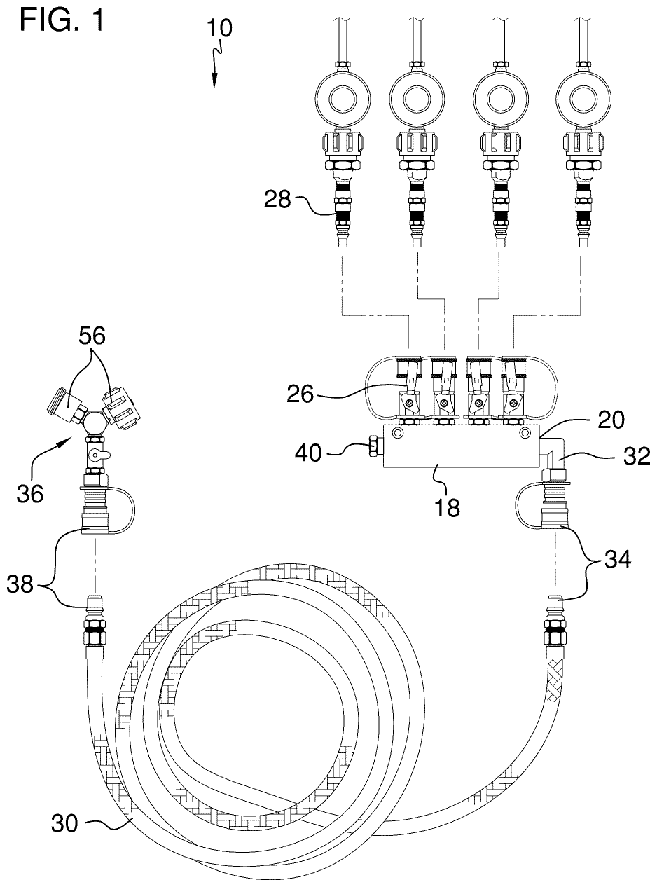

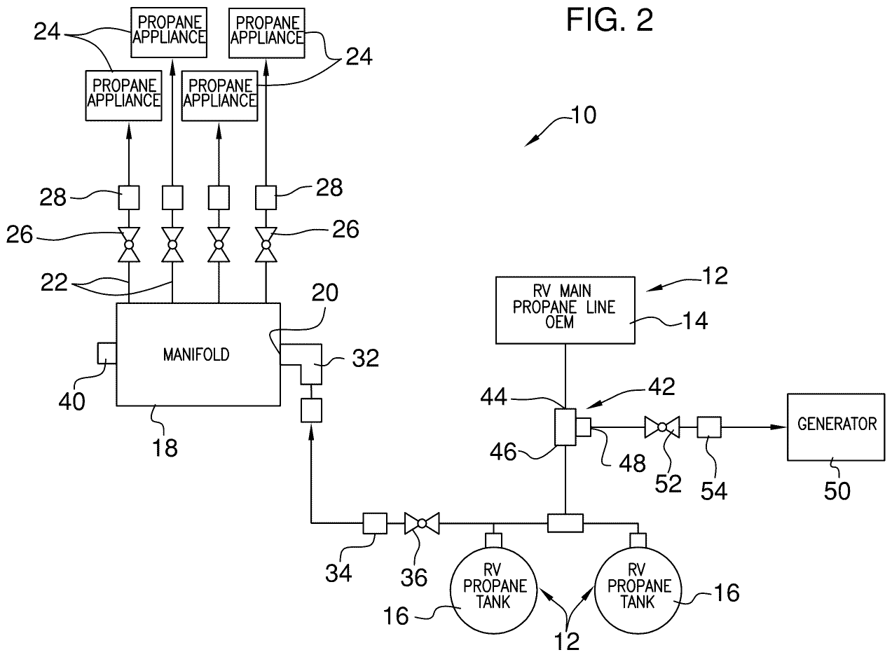

With reference now to the drawings, and in particular to FIGS. 1 through 2 thereof, a new manifold assembly embodying the principles and concepts of an embodiment of the disclosure and generally designated by the reference numeral 10 will be described.

As best illustrated in FIGS. 1 through 2, the propane manifold assembly 10 generally comprises a propane source 12 that stores a propane gas. For example, the propane source 12 may include a main propane line 14 and a plurality of propane tanks 16. Examples of the main propane line 14 include, but are not limited to, a main propane line from a recreational vehicle. The main propane line 14 may be either an original equipment manufactured line or a retrofitted line. The plurality of propane tanks 16 are typically in fluid communication with the main propane line 14, as shown in FIG. 2. Therefore, the propane gas may flow outwardly from either the main propane line 14 or the plurality of propane tanks 16.

A manifold 18 has a manifold inlet 20 and a plurality of manifold outlets 22. The manifold inlet 20 is in fluid communication with the propane source 12 wherein the propane source 12 transfers the propane gas to the manifold 18 via the manifold inlet 20.

A plurality of appliances 24 are operationally coupled to the manifold 18. More specifically, each appliance of the plurality of appliances 24 is in fluid communication with a respective manifold outlet of the plurality of manifold outlets 22. The manifold 18 transfers the propane gas from the propane source 12 to each appliance of the plurality of appliances 24 to power each appliance of the plurality of appliances 24.

A plurality of manifold valves 26 are coupled to the manifold 18. Each manifold valve of the plurality of manifold valves 26 is coupled to an associated manifold outlet of the plurality of manifold outlets 22. Therefore, each manifold valve of the plurality of manifold valves 26 is actuatable to selectively inhibit transfer of the propane gas from the associated manifold outlet of the plurality of manifold outlets 22 to an associated appliance of the plurality of appliances 24. In preferred embodiments, each manifold valve of the plurality of manifold valves 26 is a quarter-turn ball valve to facilitate the user in easily and visually determining when the plurality of manifold valves 26 are actuated.

A plurality of appliance connector fittings 28 are couplable to the plurality of manifold valves 26. Each appliance connector fitting of the plurality of appliance connector fittings 28 couples an associated manifold valve of the plurality of manifold valves 26 to the respective appliance of the plurality of appliances 24. Preferably, each appliance connector fitting of the plurality of appliance connector fittings 28 is releasably couplable to the associated manifold valve of the plurality of manifold valves 26 to facilitate storage of the plurality of appliances 24. In such embodiments, the plurality of appliances 24 can thus be disconnected from the manifold 18 by disconnecting the plurality of appliance connector fittings 28 from the plurality of manifold valves 26. For example, each appliance connector of the plurality of appliance connectors is a quick connect fitting wherein the plurality of appliance connector fittings 28 are configured to facilitate a user in disconnecting the plurality of appliances 24 from the manifold 18.

A hose 30 fluidly couples the propane source 12 to the manifold inlet 20 of the manifold 18. The hose 30 transfers the propane gas from the propane source 12 to the manifold 18. The hose 30 is a stainless steel flex hose wherein the hose 30 is configured to facilitate the user in positioning the manifold 18 relative to the propane source 12. For example, the stainless steel flex hose enables the user to position the plurality of appliances 24 at an angle relative to the propane source 12, providing the user with more flexibility for how the user wants to set up the propane dispersal assembly.

A manifold coupling 32 may be coupled to and extends from the manifold 18. The manifold coupling 32 is couplable to the hose 30 wherein the manifold coupling 32 facilitates transfer of the propane gas from the propane source 12 into the manifold 18. For example, the manifold coupling 32 may be an elbow coupling having a 90.0° bend.

A hose connector fitting 34 may couple the manifold coupling 32 to the hose 30. For example, the hose connector fitting 34 may be fixedly coupled to the hose 30 and releasably couplable to the manifold coupling 32. In another example, the hose connector fitting 34 may be removably couplable to the hose 30 and fixedly coupled to the manifold coupling 32. However, in preferred embodiments, the hose connector fitting 34 may be removably couplable to each of the hose 30 and the manifold coupling 32 to facilitate storage of the hose 30, the manifold coupling 32, and the hose connector fitting 34. More specifically, the hose connector fitting 34 is preferably releasably couplable to the manifold 18 coupling to facilitate removal of the hose 30 from the manifold 18. By removing the hose 30 from the manifold coupling 32, the propane source 12 can be disconnected from the manifold 18 for storage. The hose connector fitting 34 is preferably a quick connect fitting to facilitate the user in disconnecting the hose 30 from the manifold coupling 32.

A tank valve 36 may be coupled to the propane source 12. The tank valve 36 is actuatable to inhibit release of the propane gas from the propane source 12. In certain embodiments, the tank valve 36 may have a plurality of tank inlets 56 wherein the tank valve 36 facilitates coupling the main propane line 14 and the plurality of propane tanks 16 to the hose 30. In certain embodiments, the tank valve 36 is a quarter-turn ball valve to facilitate the user in easily and visually determining when the tank valve 36 is actuated.

A tank connector fitting 38 may couple the hose 30 to the tank valve 36. Ideally, the tank connector fitting 38 is releasably couplable to the hose 30 to facilitate removal of the hose 30 from the tank valve 36. For example, the tank connector fitting 38 may be a quick-connect fitting to facilitate the user in quickly and easily coupling the hose 30 to the tank valve 36.

A plurality of plugs 40 may be removably coupled to the manifold 18 wherein each plug of the plurality of plugs 40 is positionable on a respective manifold outlet of the plurality of manifold outlets 22. When the plurality of plugs 40 are positioned on each respective manifold outlet of the plurality of manifold outlets 22, the plurality of plugs 40 inhibit release of the propane gas through each respective manifold outlet of the plurality of manifold outlets 22.

A main line fitting 42 may be coupled to the main propane line 14 of the propane source 12. Preferably, the main line fitting 42 is a quick-connect fitting to facilitate the user in quickly and easily connecting the main line fitting 42 to the main propane line 14. For example, the main line fitting 42 may be a tee-fitting.

In such embodiments, the main line fitting 42 may have a primary outlet 44 that is in fluid communication with the main propane line 14. The primary outlet 44 facilitates transfer of the propane gas from the main propane line 14.

A secondary outlet 46 may be in fluid communication with the tank valve 36 wherein the first outlet facilitates transfer of the propane gas from the main propane source 12 to the hose 30. A tertiary outlet 48 may be couplable to a power generator 50 wherein the tertiary outlet 48 facilitates transfer of the propane gas to the power generator 50. A main line valve 52 may be coupled to the tertiary outlet 48 of the main line fitting 42 wherein the main line valve 52 is actuatable to inhibit transfer of the propane gas to the power generator 50. For example, the main line valve 52 may be a quarter-turn valve to facilitate the user in easily and visually determining when the plurality of main line valve 52 is actuated. A generator fitting 54 may be coupled to the main line valve 52 wherein the generator fitting 54 facilitates coupling the power generator 50 to the main line valve 52. Ideally, the generator fitting 54 is a quick-connect fitting to facilitate the user in quickly and easily coupling the power generator 50 to the main line valve 52.

In use, the main propane line 14 can be connected to the plurality of propane tanks 16 using the main line fitting 42. The tertiary outlet 48 of the main line fitting 42 may also be connected to the power generator 50 via the main line valve 52 and the generator fitting 54. The user can then couple the hose 30 to the propane source 12 (i.e., the main propane line 14, the plurality of propane tanks 16, or another source of the propane gas) via the tank connector fitting 38. The hose connector fitting 34 can be coupled to the hose 30 and the manifold coupling 32 to transfer the propane gas into the manifold 18. The plurality of appliances 24 can be connected to the plurality of manifold outlets 22 to facilitate transfer of the propane gas to each appliance of the plurality of appliances 24. The quick-connect fittings facilitate the user in quickly and repeatedly connecting and disconnecting this assembly.

The plurality of manifold valves 26 may be actuated to inhibit transfer of said propane gas to the plurality of appliances 24. For example, each manifold valve of the plurality of manifold valves 26 can be actuated to turn off the flow of propane gas to whichever appliances is connected to that manifold valve. To turn the flow of propane gas back on, that manifold valve can simply be actuated again. For example, when the plurality of manifold valves 26 are quarter-turn ball valves, the user can actuate the plurality of manifold valves 26 by simply turning the handle 90.0° in the appropriate direction.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A propane dispersal assembly comprising:
a propane source storing a propane gas;
a manifold having a manifold inlet and a plurality of manifold outlets, the manifold inlet being in fluid communication with the propane source;
a plurality of appliances being operationally coupled to the manifold wherein each appliance of the plurality of appliances is in fluid communication with a respective manifold outlet of the plurality of manifold outlets wherein the manifold transfers the propane gas from the propane source to each appliance of the plurality of appliances to power each appliance of the plurality of appliances;
a plurality of manifold valves being coupled to the manifold wherein each manifold valve of the plurality of manifold valves is coupled to an associated manifold outlet of the plurality of manifold outlets, each manifold valve of the plurality of manifold valves being actuatable to selectively inhibit transfer of the propane gas from the associated manifold outlet of the plurality of manifold outlets to an associated appliance of the plurality of appliances;
a plurality of appliance connector fittings being couplable to the plurality of manifold valves wherein each appliance connector fitting of the plurality of appliance connector fittings couples an associated manifold valve of the plurality of manifold valves to the associated appliance of the plurality of appliances; and
a hose fluidly coupling the propane source to the manifold inlet wherein the hose transfers the propane gas from the propane source to the manifold.

2. The propane dispersal assembly of claim 1, further comprising a tank valve being coupled to the propane source wherein the tank valve is actuatable to inhibit release of the propane gas from the propane source.

3. The propane dispersal assembly of claim 2, the propane source further comprising a main propane line and a plurality of propane tanks.

4. The propane dispersal assembly of claim 3, the tank valve further comprising a plurality of tank inlets wherein the tank valve facilitates coupling the main propane line and the plurality of propane tanks to the hose.

5. The propane dispersal assembly of claim 4, wherein the tank valve is a quarter-turn valve.

6. The propane dispersal assembly of claim 2, further comprising a tank connector fitting coupling the hose to the tank valve.

7. The propane dispersal assembly of claim 6, wherein the tank connector fitting is releasably couplable to the hose to facilitate removal of the hose from the tank valve.

8. The propane dispersal assembly of claim 7, wherein the tank connector fitting is a quick-connect fitting.

9. The propane dispersal assembly of claim 1, wherein each manifold valve of the plurality of manifold valves is a quarter-turn ball valve.

10. The propane dispersal assembly of claim 1, wherein each appliance connector fitting of the plurality of appliance connector fittings is releasably couplable to the associated manifold valve of the plurality of manifold valves to facilitate storage of the plurality of appliances.

11. The propane dispersal assembly of claim 10, wherein each appliance connector of the plurality of appliance connectors is a quick connect fitting wherein the plurality of appliance connector fittings are configured to facilitate a user in disconnecting the plurality of appliances from the manifold.

12. The propane dispersal assembly of claim 1, wherein the hose is a stainless steel flex hose wherein the hose is configured to facilitate a user in positioning the manifold relative to the propane source.

13. The propane dispersal assembly of claim 1, further comprising a manifold coupling being coupled to and extending from the manifold, the manifold coupling being couplable to the hose wherein the manifold coupling facilitates transfer of the propane gas from the propane source into the manifold.

14. The propane dispersal assembly of claim 13, wherein the manifold coupling is an elbow coupling having a 90.0° bend.

15. The propane dispersal assembly of claim 13, further comprising a hose connector fitting coupling the manifold coupling to the hose.

16. The propane dispersal assembly of claim 15, wherein the hose connector fitting is releasably couplable to the manifold coupling to facilitate removal of the hose from the manifold.

17. The propane dispersal assembly of claim 16, wherein the hose connector fitting is a quick connect fitting.

18. The propane dispersal assembly of claim 1, further comprising a plurality of plugs being coupled to the manifold wherein each plug of the plurality of plugs is positionable on a respective manifold outlet of the plurality of manifold outlets to inhibit release of the propane gas through the respective manifold outlet of the plurality of manifold outlets.

19. A propane dispersal assembly comprising:
a propane source storing a propane gas, the propane source including a main propane line and a plurality of propane tanks;
a manifold having a manifold inlet and a plurality of manifold outlets, the manifold inlet being in fluid communication with the propane source wherein the propane source transfers the propane gas to the manifold via the manifold inlet;
a plurality of appliances being operationally coupled to the manifold wherein each appliance of the plurality of appliances is in fluid communication with a respective manifold outlet of the plurality of manifold outlets wherein the manifold transfers the propane gas from the propane source to each appliance of the plurality of appliances to power each appliance of the plurality of appliances;
a plurality of manifold valves being coupled to the manifold wherein each manifold valve of the plurality of manifold valves is coupled to an associated manifold outlet of the plurality of manifold outlets, each manifold valve of the plurality of manifold valves being actuatable to selectively inhibit transfer of the propane gas from the associated manifold outlet of the plurality of manifold outlets to an associated appliance of the plurality of appliances, each manifold valve of the plurality of manifold valves being a quarter-turn ball valve;
a plurality of appliance connector fittings being couplable to the plurality of manifold valves wherein each appliance connector fitting of the plurality of appliance connector fittings couples an associated manifold valve of the plurality of manifold valves to the respective appliance of the plurality of appliances, each appliance connector fitting of the plurality of appliance connector fittings being releasably couplable to the associated manifold valve of the plurality of manifold valves to facilitate storage of the plurality of appliances, each appliance connector of the plurality of appliance connectors being a quick connect fitting wherein the plurality of appliance connector fittings are configured to facilitate a user in disconnecting the plurality of appliances from the manifold;
a hose fluidly coupling the propane source to the manifold inlet of the manifold wherein the hose transfers the propane gas from the propane source to the manifold, the hose being a stainless steel flex hose wherein the hose is configured to facilitate the user in positioning the manifold relative to the propane source;
a manifold coupling being coupled to and extending from the manifold, the manifold coupling being couplable to the hose wherein the manifold coupling facilitates transfer of the propane gas from the propane source into the manifold, the manifold coupling being an elbow coupling having a 90.0° bend;
a hose connector fitting coupling the manifold coupling to the hose, the hose connector fitting being releasably couplable to the manifold coupling to facilitate removal of the hose from the manifold, the hose connector fitting being a quick connect fitting;
a tank valve being coupled to the propane source wherein the tank valve is actuatable to inhibit release of the propane gas from the propane source, the tank valve having a plurality of tank inlets wherein the tank valve facilitates coupling the main propane line and the plurality of propane tanks to the hose, the tank valve being a quarter-turn ball valve;
a tank connector fitting coupling the hose to the tank valve, the tank connector fitting being releasably couplable to the hose to facilitate removal of the hose from the tank valve, the tank connector fitting being a quick-connect fitting; and
a plurality of plugs being coupled to the manifold wherein each plug of the plurality of plugs is positionable on a respective manifold outlet of the plurality of manifold outlets to inhibit release of the propane gas through the respective manifold outlet of the plurality of manifold outlets.
